(19) United States
(12) Patent Application Publication
(10) Pub. No.: US 2004/0261029 A1
(43) Pub. Date: Dec. 23, 2004

(54) Method for flexible diagram generation and presentation tool

(76) Inventor: Geir Ove Skjaervik, Salsbruket (NO)

Correspondence Address: CHRISTIE, PARKER & HALE, LLP, PO BOX 7068, PASADENA, CA, 91109-7068, US

(21) Appl. No.: 10/492,864

(22) PCT Filed: Oct. 14, 2002
(86) PCT No.: PCT/NO02/00372

(30) Foreign Application Priority Data
Oct. 15, 2001 (US) 60329289

(51) Int. Cl. G09G 5/00

(52) U.S. Cl. 715/734

(57) ABSTRACT

A method for flexible generation and presentation of diagrams on a computer display consisting of elements and connections between these elements displaying a diagram either partially or in full, allowing multiple occurrences of the same element, allowing redundancy of the same element, using diagram elements with different shapes and functions, displaying an element with all elements it has connections to next to it in a diagram called a Normal Diagram, displaying an element with all elements it has connections from next to it in a diagram called an Inverse Diagram, generating and/or displaying any partial diagram with any element in the diagram as a starting point, displaying arbitrarily complex diagrams in a simplified/collapsed manner, displaying traversing and editing large and complex diagrams easily in a limited amount of space by collapsing and expanding elements, in a Normal Diagram only allowing the Entrance Port(s) of any Shadow A to receive Connection(s) from the Exit Port(s) of one Shadow B at any time while the Exit Port(s) may each connect to the Entrance Pont(s) of zero or many other Shadows, in an Inverse Diagram only allowing the Exit Port(s) of any Shadow A to connect to the Entrance Port(s) of one Shadow B at any time while the Entrance Port(s) may each receive connections from the Exit Port(s) of zero or many other Shadows and displaying Normal- and Inverse diagram at the same time in a 3D diagram.

The present invention is related to a method for flexible generation and presentation tool of Diagrams, according to the preamble of the claims.

In every engineering practice there is a need to draw diagrams to express the functionality of a design. Within complex projects the diagram will grow to become large and very hard to interpret. The process of drawing and interpreting these diagrams is very time consuming and expensive, and the information the diagrams were meant to convey, communicates badly.

All these diagrams consist of elements and connections between these elements, and thus diagrams can be represented as a graph with elements and connections between them. The connections may be directional, i.e. pointing only in one direction from one element to another, or bi-directional, i.e. pointing from one element to another and back again. These diagrams will be called Standard Diagrams in the following discussion. When there is no ambiguity we will just call them Diagrams. The term Shadow Diagram will be used to denote the present invention.

Standard Diagrams work well as long as the complexity of the design is simple and thus the diagrams are small. The problem with standard diagrams is dealt with by using a lot of time and energy trying to understand large and complex diagrams. Another approach is to break down large diagrams into smaller sub diagrams and putting a lot of effort in reading and understanding the relationship between many sub diagrams. Typical diagrams used today are electrical/electronic diagram, organization charts, class diagrams for software, process control systems, power plants and many other types of installations.

All types of diagrams mentioned above, convey important information to their respective users. However, they all have a common problem. Since the computer screen has a limited size (and so has paper), it gets increasingly difficult to read the information as the size of the diagrams grows outside the bounds of the computer screen. In addition, if the diagram consist of many elements and connections run from one end of the diagram to the other crossing each other in a mangled way, it can be very difficult to interpret information presented in the diagram.

The above mentioned disadvantages and short comings of prior art are avoided with a flexible diagram generation and presentation tool according to the present invention as defined by the features stated in the claims.

The present invention will be described in more detail in the following in connection with some examples and with references to the drawings, where

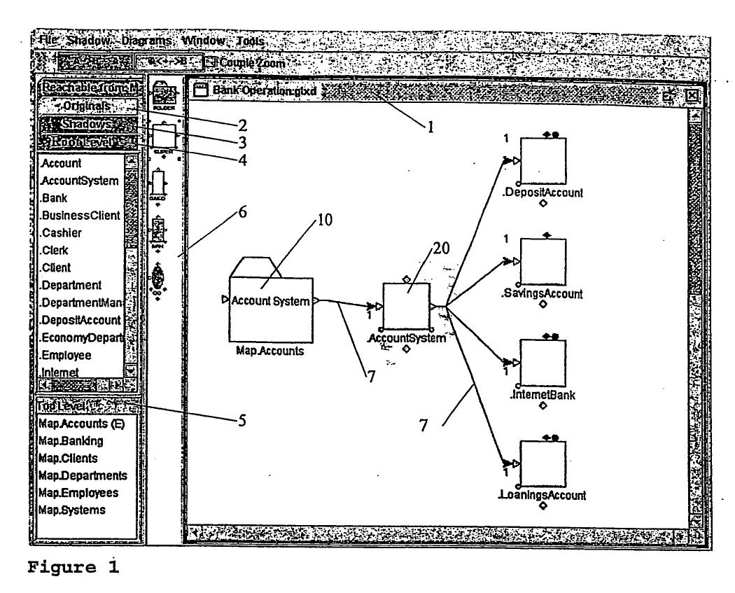

FIG. 1 disclose the user interface for the sample Shadow Diagram Editor,

FIG. 2 disclose a Normal and Inverse Shadow Diagram where the left window shows Normal Shadow

Diagram and right window shows Inverse Shadow Diagram for an Account System diagram,

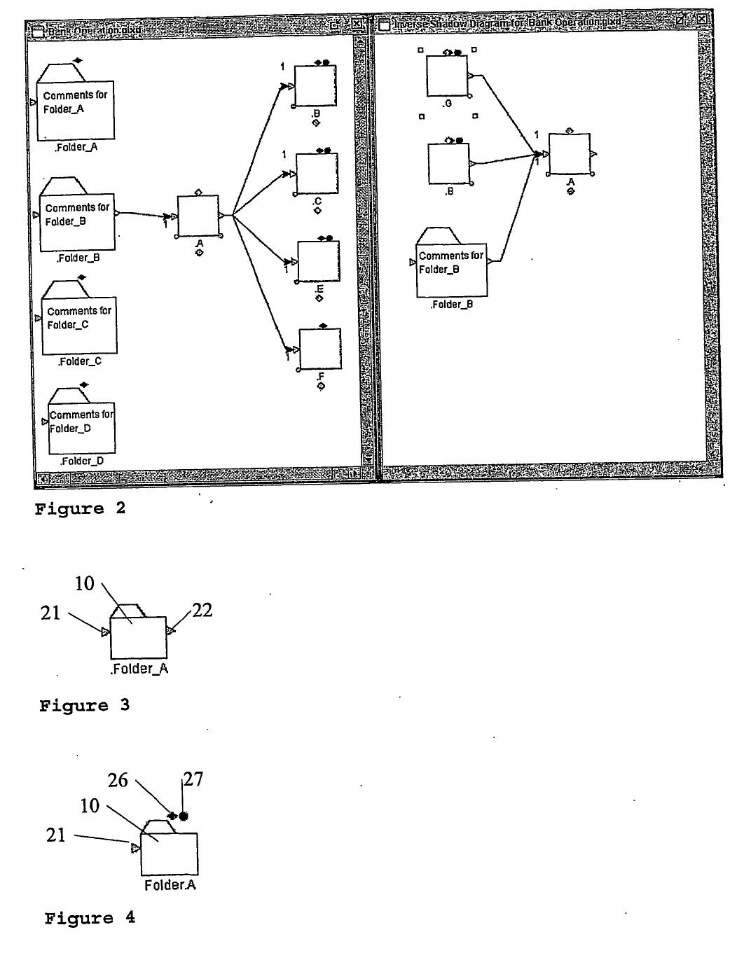

FIG. 3 disclose typical Folder Element,

FIG. 4 disclose typical Collapsed Folder Element

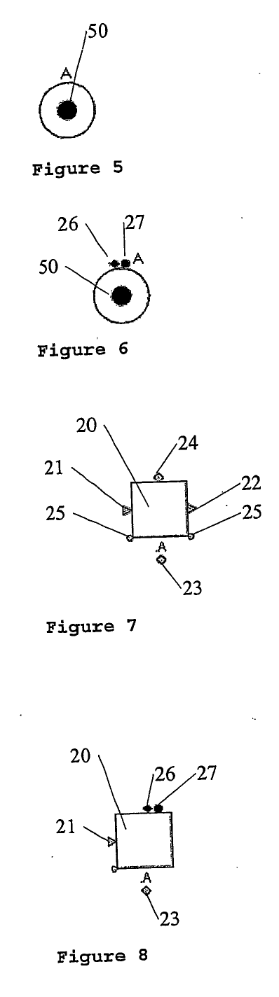

FIG. 5 disclose typical Uno Shadow,

FIG. 6 disclose typical Collapsed Uno Shadow,

FIG. 7 disclose typical SiSo Shadow Element,

FIG. 8 disclose typical Collapsed SiSo Shadow element,

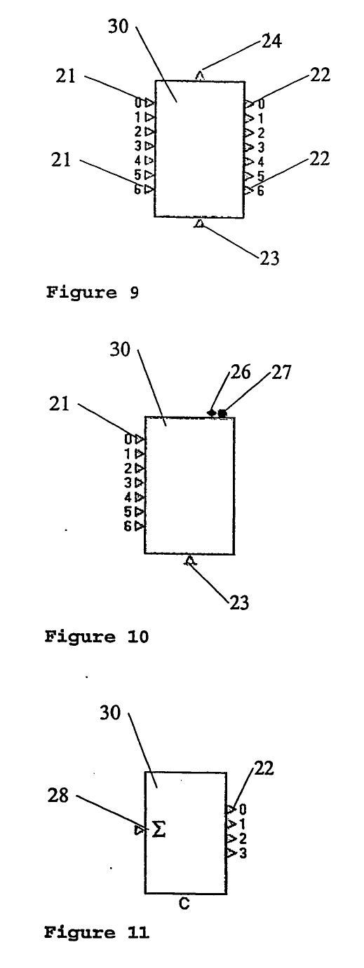

FIG. 9 disclose typical MiMo Shadow element,

FIG. 10 disclose typical Collapsed MiMo Shadow element,

FIG. 11 disclose a MiMo Shadow with Collapsed Input Connection indicated by the Σ symbol near the Input Port,

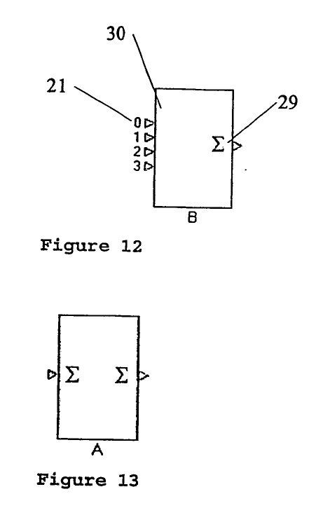

FIG. 12 disclose a MiMo Shadow with Collapsed Output Connection indicated by the Σ symbol near the Output Port,

FIG. 13 disclose a MiMo so Shadow with Collapsed Input and Output Connection indicated by the Σ symbol near the Input and Output Port,

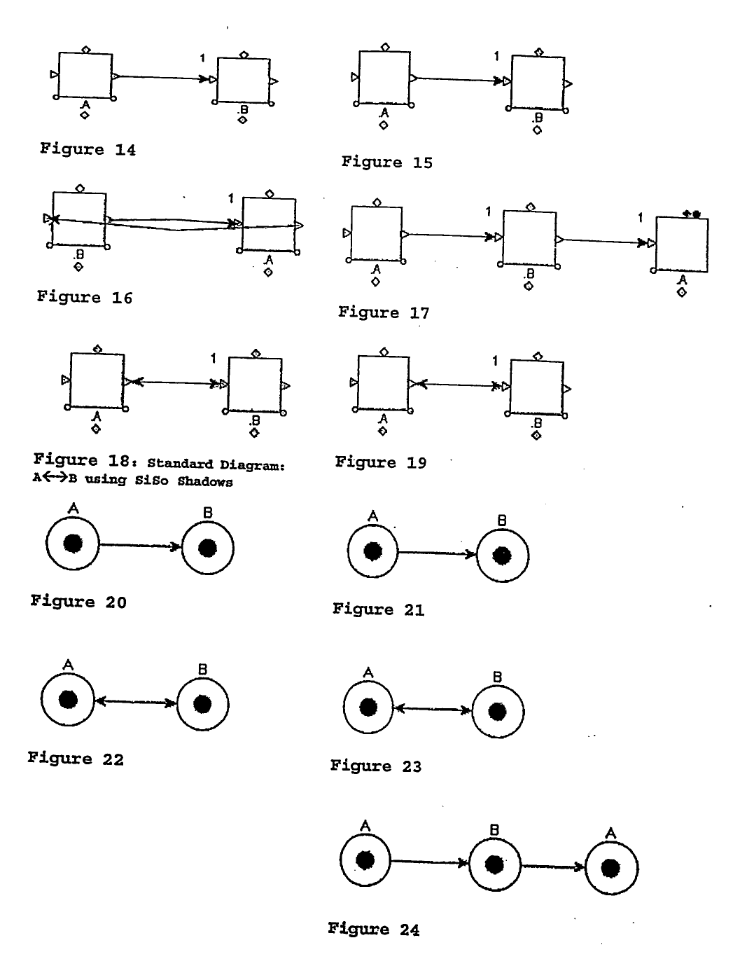

FIG. 14 disclose a Standard Diagram with A→B,

FIG. 15 disclose a Shadow Diagram with A→B,

FIG. 16 disclose a Standard Diagram with A→B and B→A using SiSo Shadows,

FIG. 17 disclose a Shadow Diagram with A→B and B→A using SiSo Shadows,

FIG. 18 disclose a Standard Diagram with A←→B using SiSo Shadows,

FIG. 19 disclose a Shadow Diagram with A←→B using SiSo Shadows,

FIG. 20 disclose a Standard Diagram with AB using Uno Shadows,

FIG. 21 disclose a Shadow Diagram with A→B using Uno Shadows,

FIG. 22 disclose a Standard Diagram with A←→B using Uno Shadows,

FIG. 23 disclose a Shadow Diagram with A←→B using Uno Shadows and Bidirectioal connections,

FIG. 24 disclose a Shadow Diagram with A←→B using Uno Shadows and Unidirectioal connections,

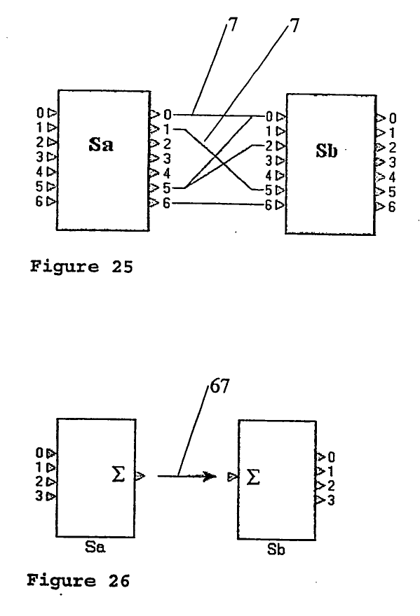

FIG. 25 disclose MiMo Group Connection with local non-planarity,

FIG. 26 disclose Mimo Shadow with Collapsed Group Connection indicated with the Σ near the Output Port of Sa and near the Input Port of Sb,

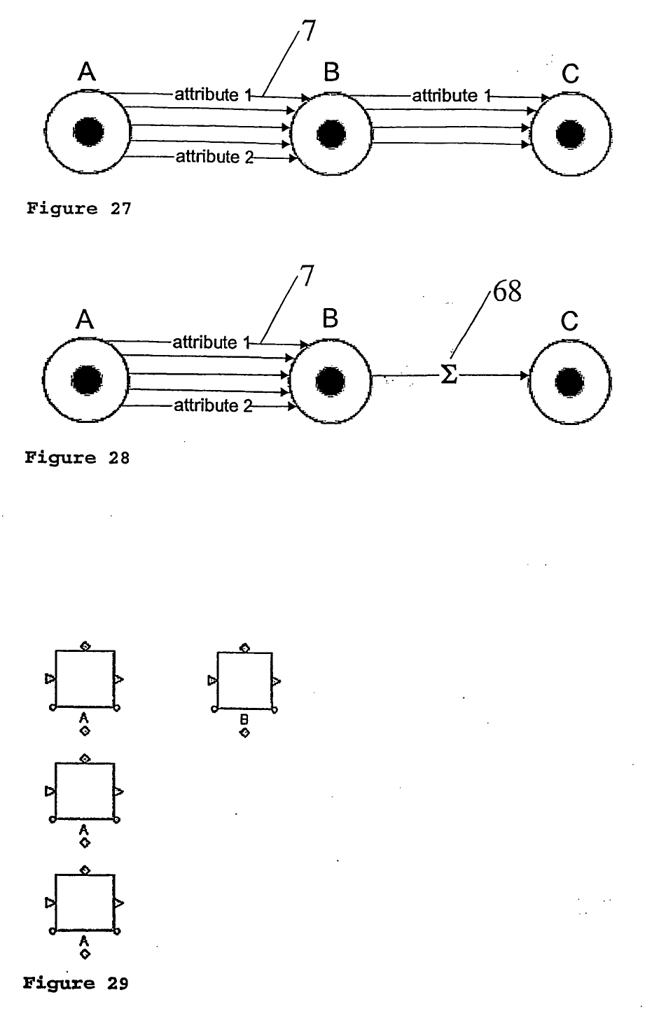

FIG. 27 disclose Uno Group Connections,

FIG. 28 disclose Uno Group Connections: Connection between B and C is Collapsed,

FIG. 29 disclose an example of Shadow Connection Add Rule before adding a connection between uppermost A and B,

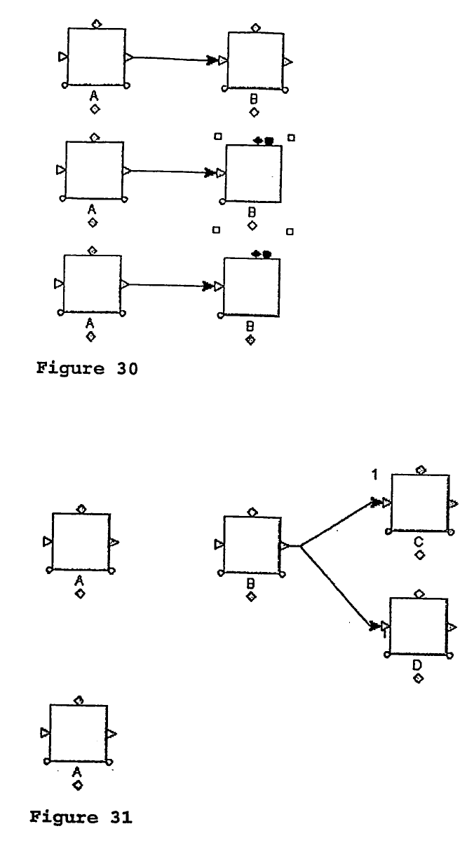

FIG. 30 disclose what has happended after adding connection between the uppermost Shadow A and B in FIG. 29,

FIG. 31 disclose another example of Shadow Connection add rule before adding a connection between the uppermost A and B,

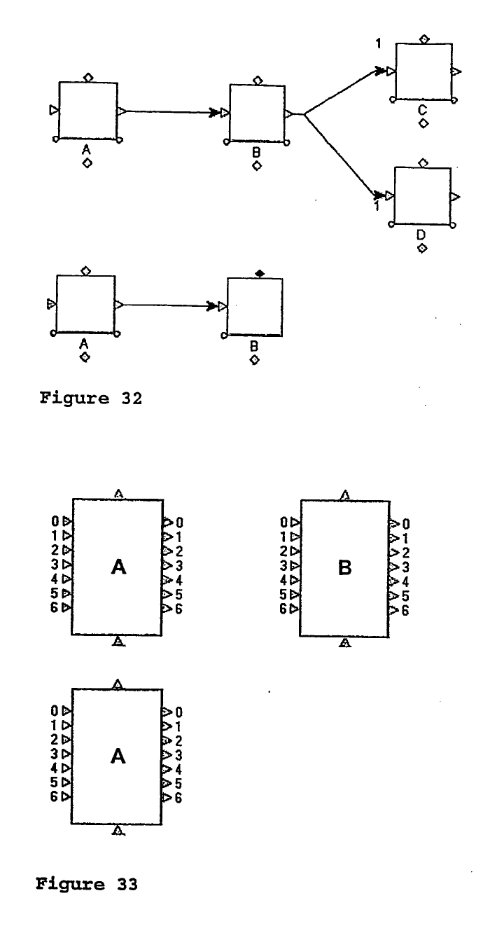

FIG. 32 disclose what has happened after adding connection between the uppermost A and B, in FIG. 31,

FIG. 33 disclose an example of Shadow Connection add rule using MiMo Shadows, before adding the first connection between the uppermost A and B,

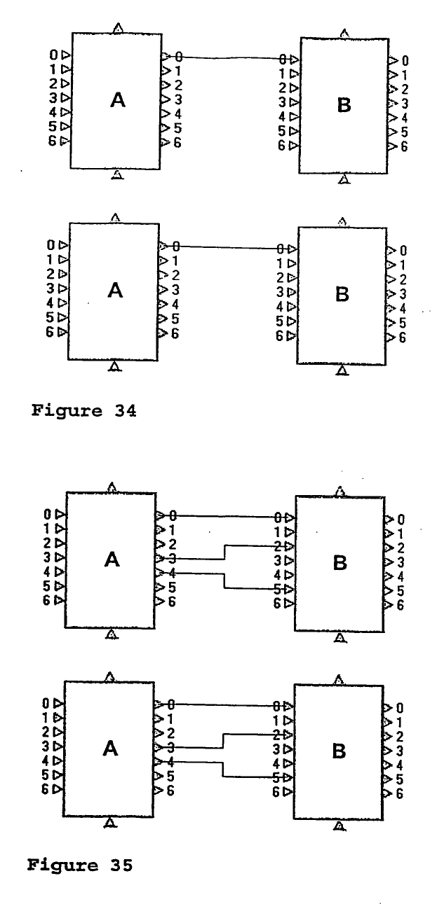

FIG. 34 disclose what has happened after adding the first connection between the uppermost A and B, in FIG. 33,

FIG. 35 disclose what has happened using MiMo Shadows after adding more connections between Port A.3→B.2 and A.4→B.5 for the uppermost A and B in FIG. 34,

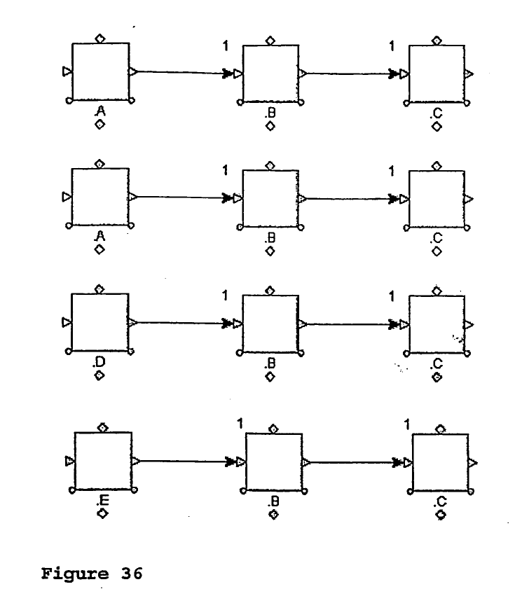

FIG. 36 disclose a Shadow Diagram before deleting uppermost Shadow B,

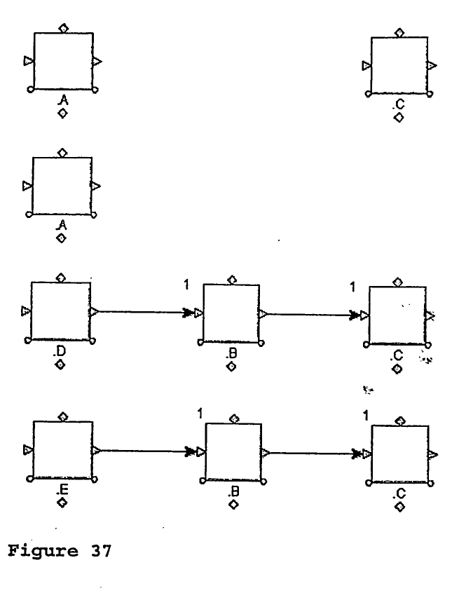

FIG. 37 disclose what has happened after deleting uppermost Shadow Bin FIG. 36,

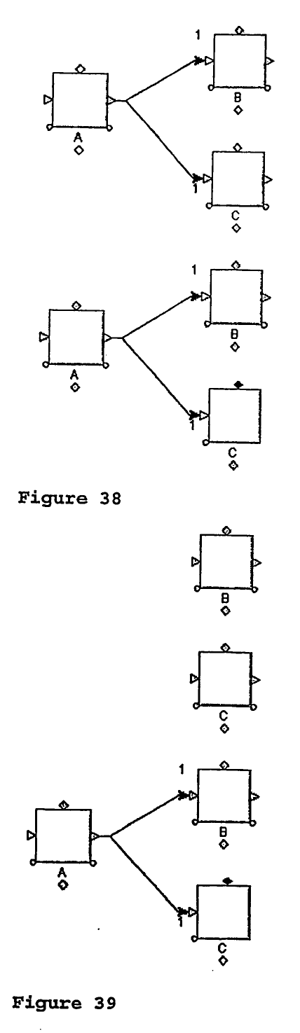

FIG. 38 disclose a Shadow Diagram before deleting uppermost Shadow A.

FIG. 39 disclose what has happened after deleting uppermost Shadow A in FIG. 38,

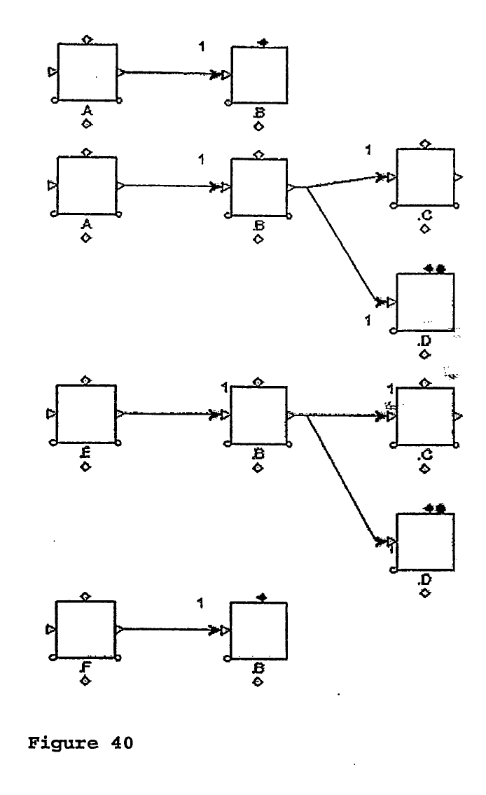

FIG. 40 disclose a Shadow Diagram before deleting uppermost Collapsed Shadow B,

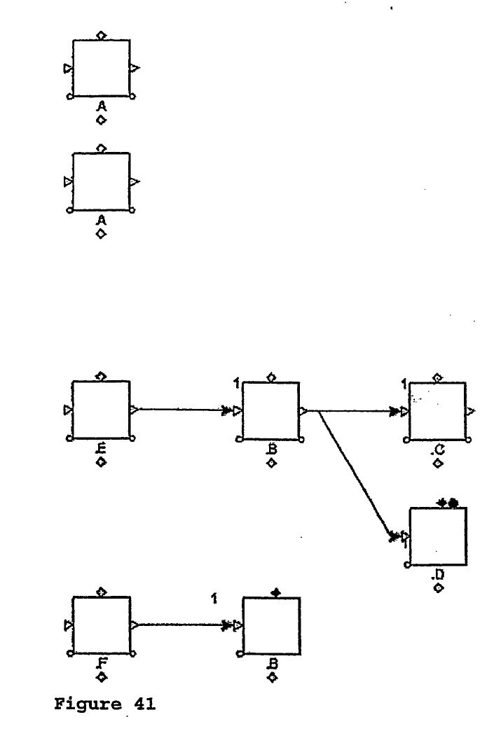

FIG. 41 disclose what has happened after deleting uppermost Collapsed Shadow B in FIG. 40,

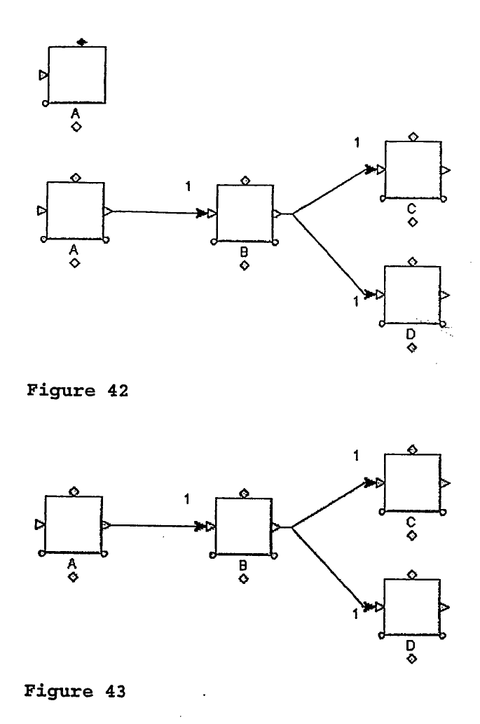

FIG. 42 disclose a Shadow Diagram before deleting upper Collapsed Shadow A,

FIG. 43 disclose what has happened after deleting upper Collapsed Shadow A in FIG. 42,

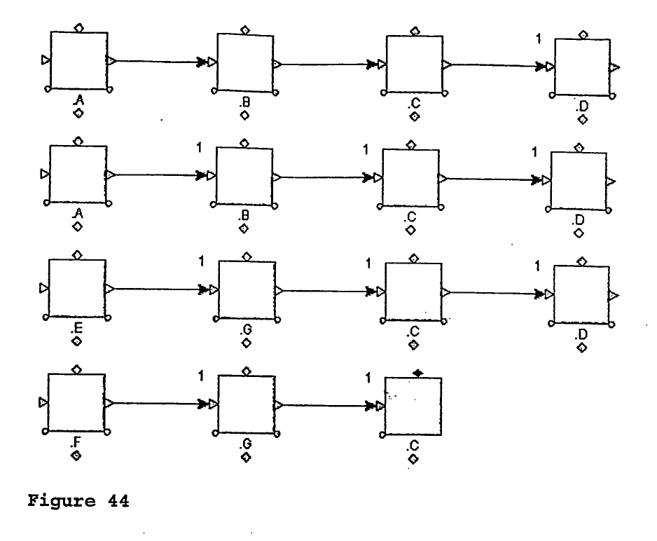

FIG. 44 disclose a Shadow Diagram before deleting uppermost Connection B→C,

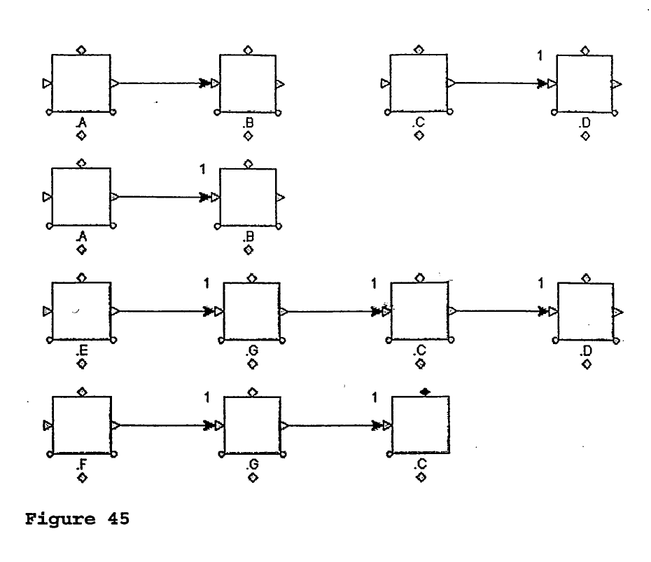

FIG. 45 disclose what has happened after deleting uppermost Connection B→C in FIG. 44,

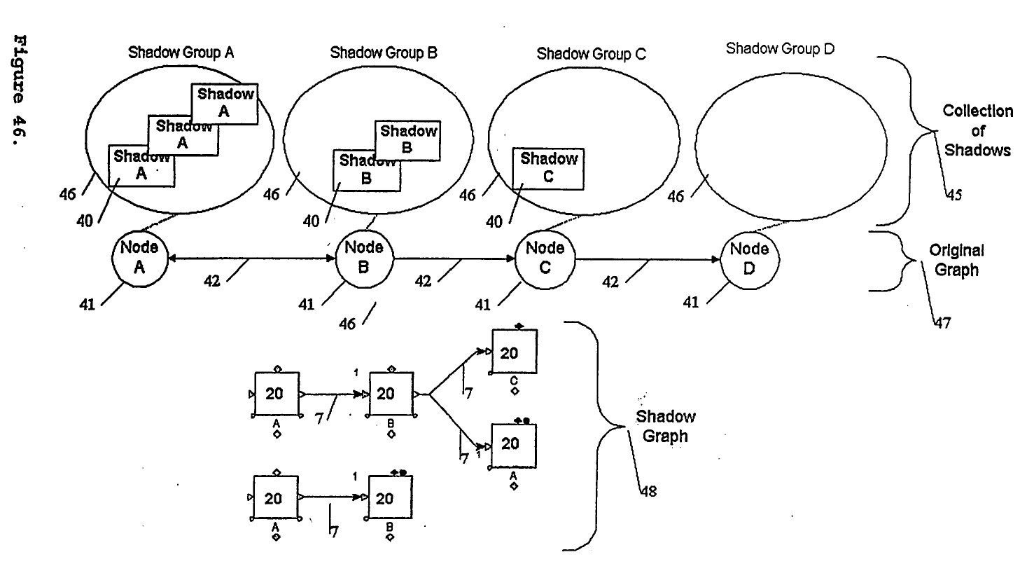

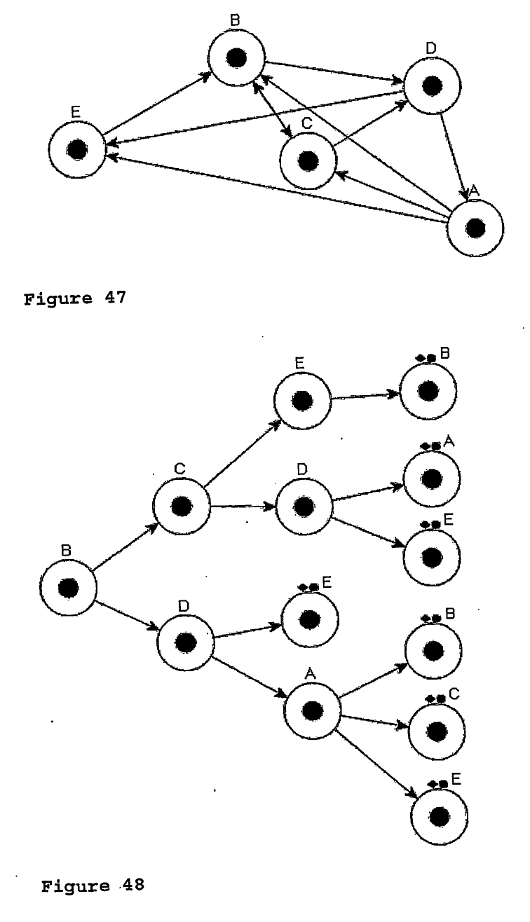

FIG. 46 disclose the relationship between Orignal Graph, Shadow Graph and Shadow Groups,

FIG. 47 disclose a simple non-planar Standard Diagram using Uno Elements being equivalent to the standard diagram in FIG. 50,

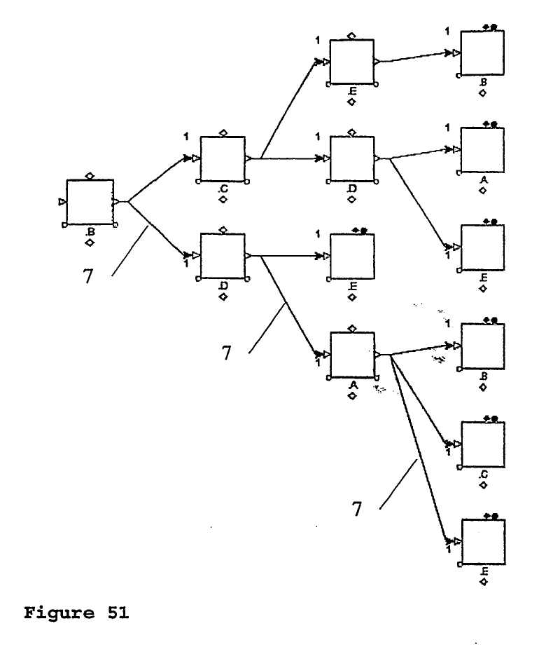

FIG. 48: disclose a Normal Shadow Diagram using Uno Shadows for the Standard Diagram in FIG. 47., being equivalent to the normal shadow diagram in FIG. 51,

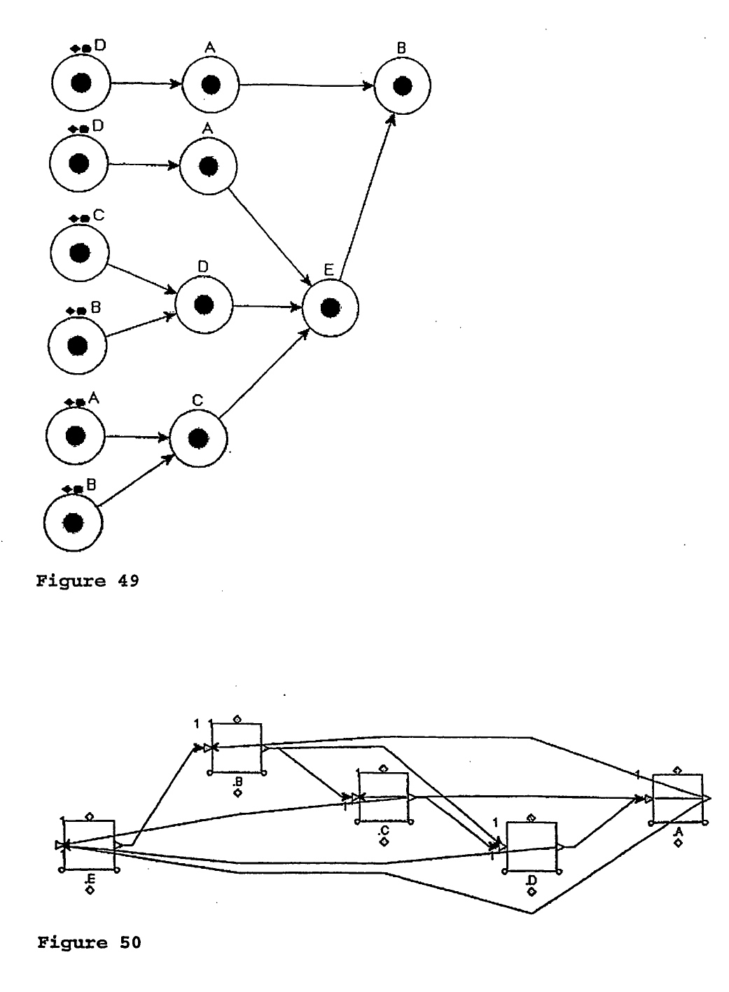

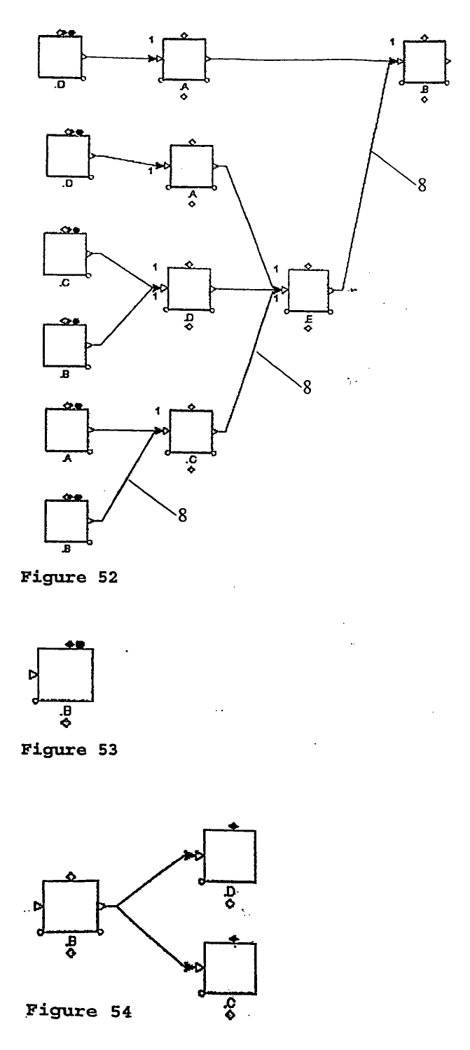

FIG. 49 disclose an Inverse Shadow Diagram using Uno Shadows for the Standard Diagram in FIG. 47, being equivalent to the inverse shadow diagram in FIG. 52,

FIG. 50 disclose a Simple non-planar Standard Diagram,

FIG. 51 disclose a Normal Shadow Diagram for the Standard Diagram in FIG. 50, expanded 4 and (3) levels from Shadow B,

FIG. 52 disclose an Inverse Shadow Diagram for the Standard Diagram in FIG. 50, expanded 3 levels from Shadow B,

FIG. 53 disclose a Normal Shadow Diagram from FIG. 51 fully Collapsed to B, where Reset Layout Operation has been performed,

FIG. 54 disclose a Normal Shadow Diagram from FIG. 53, where B has been Expanded,

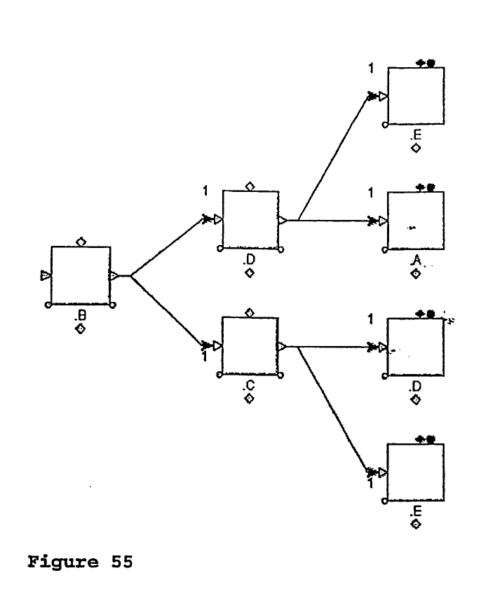

FIG. 55 disclose a Normal Shadow Diagram from FIG. 54, where C and D has been Expanded,

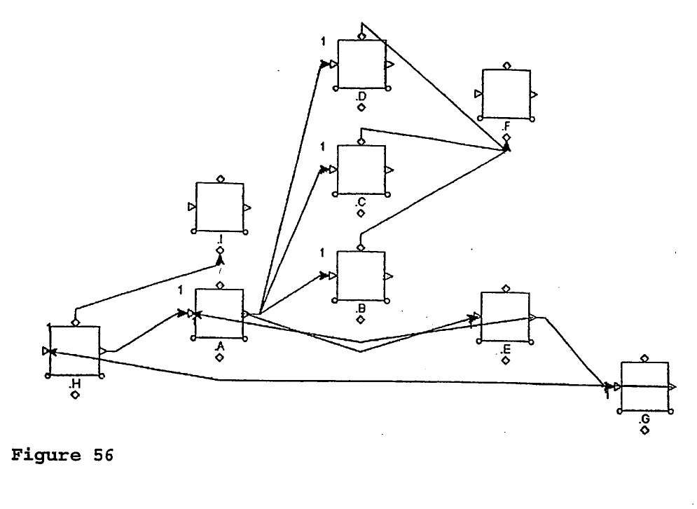

FIG. 56 disclose a typical Standard Diagram,

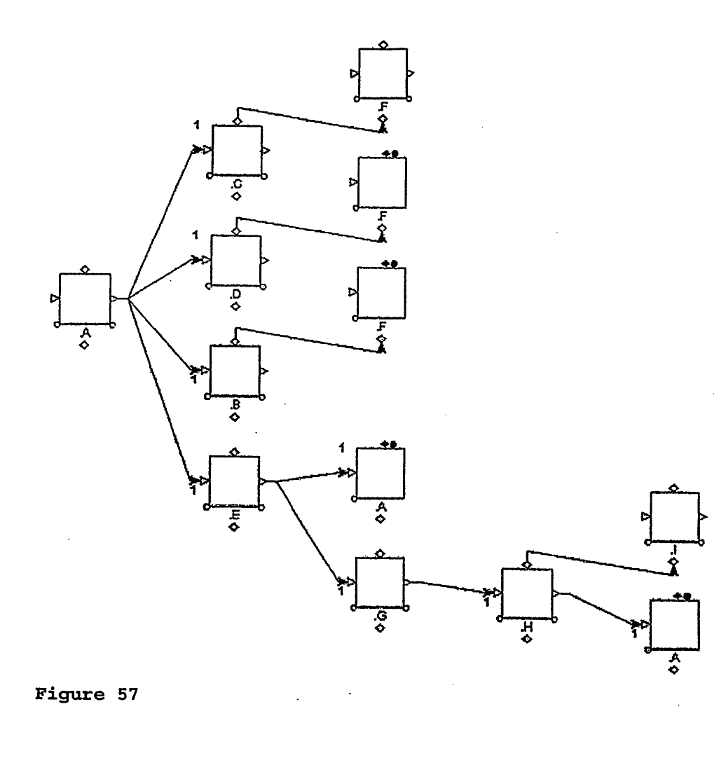

FIG. 57 disclose a Normal Shadow Diagram for Standard Diagram in FIG. 56,

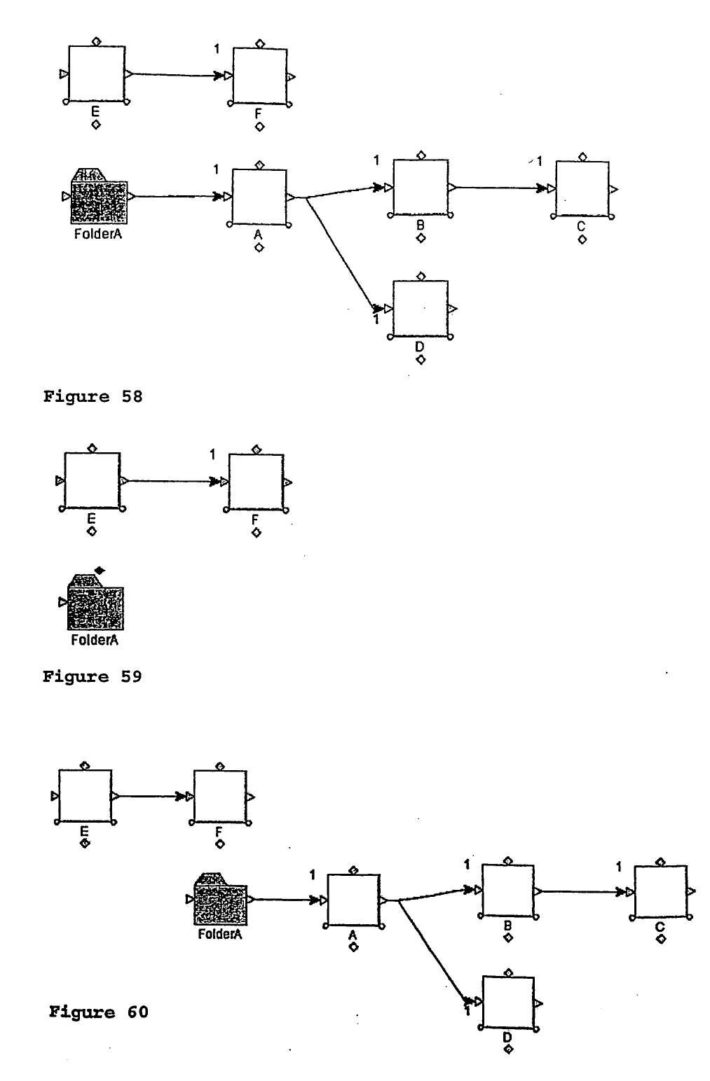

FIG. 58 disclose a Shadow Diagram with a Folder before Collapsing the folder,

FIG. 59 disclose the Shadow Diagram in FIG. 58 after Collapsing Folder in FIG. 58,

FIG. 60 disclose the Shadow Diagram in FIG. 59 after FolderA has been moved and expanded,

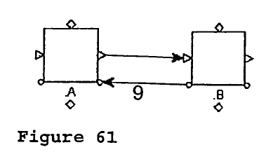

FIG. 61 disclose the use of a non-associative connection to represent a Bi-directional connection,

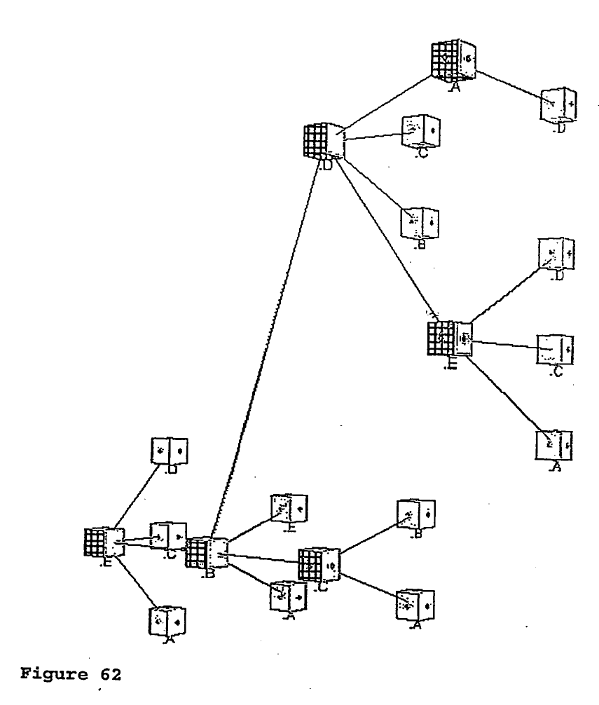

FIG. 62 disclose a 3D Shadow Diagram where the Shadows from the Normal Diagram are hatched and the Shadows from the Inverse Diagram are not,

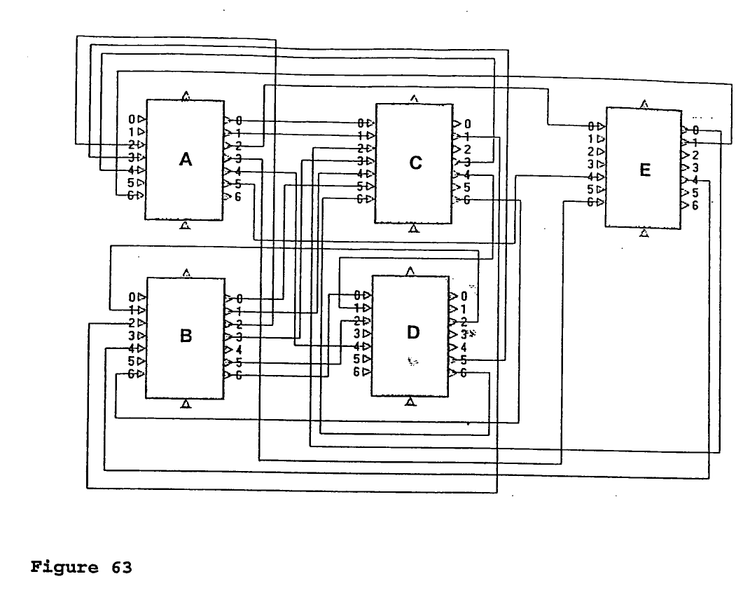

FIG. 63 disclose a Standard Diagram using MiMo elements,

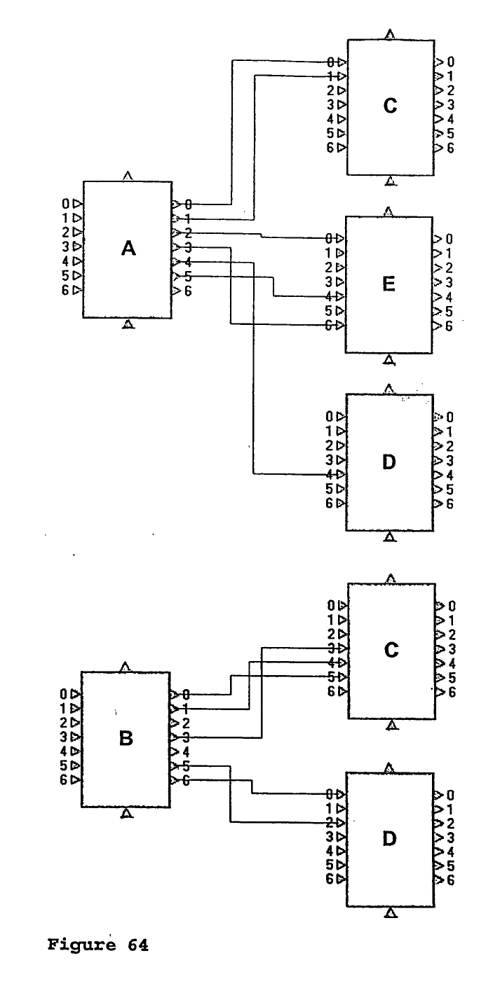

FIG. 64 disclose a Normal MiMo Shadow Diagram of the Standard Diagram in FIG. 63 with only Elements A and B inspected,

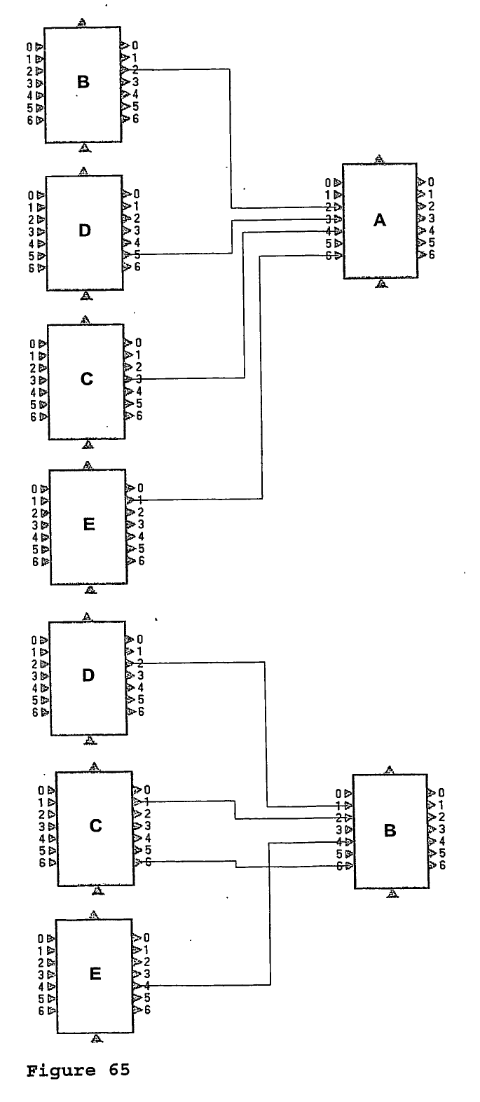

FIG. 65 disclose an Inverse MiMo Shadow Diagram of the Standard Diagram in FIG. 63 with only Elements A and B inspected,

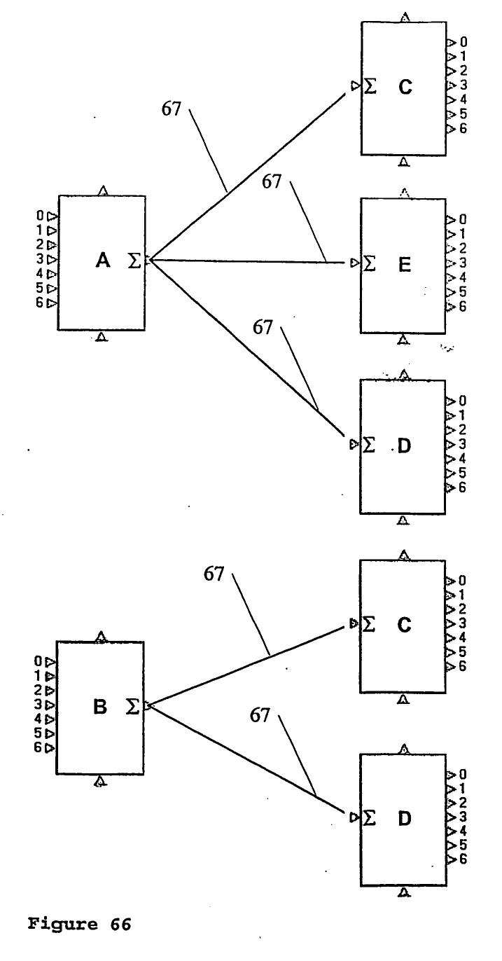

FIG. 66 disclose a Normal MiMo Shadow Diagram from FIG. 64 with Collapsed Group Connections.

The present invention provides an alternative way of representing & editing the information in a diagram on a computer screen, and makes it easy to navigate even large and complex diagrams that are very difficult to interpret using prior art. If a diagram may be drawn without any connection crossing another connection, then the diagram is said to be planar, otherwise it is non-planar. For a person it is in general easier to interpret a planar than a non-planar diagram. Diagrams drawn with the present invention will always be planar, but may display local non-planarity when using the Multiple input/Multiple output (MiMo) Shadows. In a Shadow Diagram, all elements that an element B connects to, i.e. the visible elements, will always be located in the immediate vicinity of element B as can be seen in FIG. 51 and FIG. 52). Thus, there will be no elements in between; and thereby easier to navigate the diagram starting at any element even though only part of the diagram is seen through the computer screen.

The present invention achieves this using the principles of Multiple occurrences of any element, and the principle of so-called right- and left-associative connections. Given an Element B, it's right Associative Connections, shown as 7 in FIG. 51, represent all Elements that B's Exit Port connect to. Left Associative Connections, shown as 8 in FIG. 52, represent all Elements that connect to B's Entrance Port. Right Associative Connections 7 are all Connections pointing from B. In Graph theory these are B's Outgoing Edges. Left Associative Connections 8 are all Connections pointing to B. In Graph theory these are B's Incoming Edges.

Non Associative Connections, shown as 9 in FIG. 61, may be used to represent a connection from element B to e.g. element A when there already is an Associative connection from A to B. These principles and the use of Normal and Inverse Diagrams, described herein, ensure that the diagrams will always be directed and planar even when representing diagrams with bi-directional connections, but may display local non-planarity

Diagrams are interpreted differently in different contexts. Consider the Standard Diagrams shown in FIG. 16, FIG. 18 and FIG. 22. A Software Engineer will most probably interpret these diagrams the same way: Class A has connection to Class B and Class B has connection to Class A. Port identity is not significant; ports are only convenient connection points.

An Electrical Engineer would think of this quite differently. From FIG. 16 he would read that the output port of Circuit A goes to the input port of Circuit B and the output port of Circuit B goes to the input port of Circuit A. Further, the direction of the connections would not mean anything (would be omitted) since electrical connectors are bidirectional by nature. The electrical engineer would read FIG. 18 as Output port of Circuit A is connected to input port of Circuit B. FIG. 22 most probably does not make much sense at all. Thus the interpretation of the ports is significant.

In our discussion, we will treat ports as significant, but the reader should understand that interpretation depends upon the context. Further, to avoid an inflation in the number of figures, most Shadow Diagrams are drawn using Unidirectional Connections only. However, these connections may be interpreted as either unidirectional or bidirectional depending on the context.

Consider the following Types of Shadows: Single Input/Single Output (SiSo) Shadows, shown in FIG. 7, Multiple Input/Multiple Output (MiMo) Shadows, shown in FIG. 9, and Uno Shadows shown in FIG. 5. The SiSo Shadow is a special Case of the MiMo, where the SiSo shadow only has one instance of each category of Entrance and Exit Ports.

With reference to the FIGS. 1, 3 5, 7 and 9, the present invention uses the following types of elements, but not limited to, when building a diagram—Folder element 10, Uno 50, SiSo 20 or MiMO 30 Shadow elements. The shadow-element represents the element being drawn in the diagram, and is equivalent with an element in a Standard Diagram, described below, but behaves differently as described in the Connection, Add and Delete Rules herein. The Folder-element 10 is an “imaginary” element that only serves to group other elements or Folders. A Folder-element can connect to other Folder- and/or shadow elements according to given Connection Rules, while a Shadow element usually only can connect to other shadow elements according to the Connection Rules. We also permit that Shadows connect to Folders in contexts where this has a meaning. Usually a Diagram only uses one Type of Shadow. Thus usually one type of Shadow only has connection to the same type of Shadow. However this is not a limitation, in contexts where this is practical, a mix of different types of Shadows may be used in the same diagram.

All Shadows have Ports. A Port is a point where a connector may be attached to create a Connection. With reference to FIG. 7, the ports 21, 22, 23 and 24 may be categorized as Entrance and Exit ports. The Input 21 and Subclass 23 ports are Entrance-ports. Output 22 and Superclass 24 ports are Exit-ports. We say that Input and Subclass ports belong to the Entrance Port Category, but they are of different Types. Output and Superclass ports belong to the Exit Port Category. Input and Output Ports are of Type Relationship. Subclass and Superclass Ports are of Type Inheritance (or Generalization).

A SiSo Shadow has one Input Port 21, typically on the left side, and one Output port 22, typically on the right side. Further it may have a Subclass Port 23, typically at the bottom, and a Superclass Port 24, typically at the top. The Input and Output ports are used to create a Relationship between the elements, just as it is in a standard diagram. The Subclass 23 and Superclass 24 ports are used to represent Inheritance relationships as known from inheritance between people, or between Classes in an Object Oriented software system. Inheritance may not have any meaning in some contexts, in which case the Inheritance ports will be omitted.

When a Shadow element is Collapsed, described herein, the Exit Ports are hidden.

A SiSo (and MiMo and Uno) Shadow may very well support other types of Entrance and Exit Ports, but the same rules apply to those ports.

Shadow elements are connected to each other by creating a connection from an Exit Port of one Shadow element, to the Entrance Port of another Shadow element. Only specific connections are allowed according to the Connection Rules described herein.

A Shadow Element may also be collapsed. With reference to FIG. 8 a Collapsed Shadow Element has a special symbol, typically a blue Diamond (26) that indicates that the Shadow Element is collapsed. A Collapsed Shadow Element may also have the layout of its collapsed elements “reset”. This is typically indicated by a red Dot 27. FIG. 8 shows a SiSo element, but the same applies to the other kinds of shadow elements described herein.

With reference to FIG. 9, a MiMo Shadow has Multiple Entrance and Multiple Exit Ports. It has multiple Input ports 21, typically on the left side, and multiple output ports 22, typically on the right side. It may also have a Subclass port 23 and a Superclass port 24 typically at the bottom and top respectively. Usually there is only one superclass 24 and one subclass 23 port although this is not a restriction. Connections to a MiMo Shadow follow the Connection Rules, described herein. Just as a SiSo shadow, a MiMo Shadow may also support other types of Entrance and Exit ports.

There may be an arbitrary number of associative 7, 8 and non-associative 9 connections between two MiMo Shadow Elements A and B. The Normal Shadow Diagram in FIG. 25 shows multiple right associative connections 7 between the MiMo Shadow A and B. Furthermore, the Group Connection between A and B may be Collapsed 67 as shown in FIG. 26.

With reference to FIG. 5, an Uno Shadow has may be regarded as having an unlimited number of invisible entrance and exit ports. Every connection may be regarded as an Entrance or Exit connection depending on the direction and/or the Attributes of the Connection. Physically the connections may all go to the same point of the Element or be distributed over the outer bounds of the element.

There may be an arbitrary number of associative and non-associative connections between two Uno Shadow Elements A and B. FIG. 27 shows multiple right associative connections 7 between Uno Shadows A and B and between B and C. Furthermore, the Group Connection between B and C may be collapsed 68 as shown in FIG. 28.

Shadow Diagrams uses, but are not limited to, two Categories of connections between the elements in a diagram, i.e. Unidirectional and Bidirectional connections. Within each category, the connections may have any shape and combination of attributes. Contexts such as electrical engineering, will prefer to use unidirectional connections. This is achieved by simply drawing the connections above as undirectional disregarding the physical implementation.

An unidirectional connection from element A to element B has a connection from A to B with an Arrow at the end of the connection near B, pointing to B. It is denoted as A→B.

An unidirectional connection from element B to A has a connection from B to A with an Arrow at the end of the connection near A, pointing to A. It is denoted as A←B. A bidirectional connection between element A and B consis of a connection from A to B with an Arrow at the end of the connection near B pointing to B and an Arrow at the end of the connection near A pointing to A. It is denoted as A←→B.

Connections between MiMo Shadows also indicates which Ports participate in a connection: A.x→B.y means that Port x of MiMo Shadow A connects to Port y of MiMo Shadow B.

When using Uno Shadow elements, a Shadow Diagram may be drawn in Unidirectional or Bidirectional Mode. Given the Standard Diagram using Uno elements as shown in FIG. 22, using Uno Shadows, the Shadow Diagram may be drawn in two modes, Unidirectional Mode or Bidirectional Mode.

In the Unidirectional Mode the Shadow Diagram is displayed using only Unidirectional connections as shown in FIG. 24. The connections are drawn according to the Connection Rules described herein. Multiple Shadows are used for shadow element A to represent the bidirectional connection in the Standard Diagram in FIG. 22.

In the Bidirectional Mode, Bidirectional connections from the Standard Diagram are simply drawn as Bidirectional connections in the Shadow Diagram (FIG. 23), and multiple Shadows are not used to represent the bidirectional connection. Other than this, we follow the same connection Rules as in Unidirectional Mode.

The interpretation of a Unidirectional or Bidirectional connection depends upon the context. In Electrical Engineering connections are almost always regarded as bidirectional, since they usually represent electrical wires that conduct electricity in both directions. In Software Engineering the connections ofteri represent relations between Classes. These relations are directional, i.e. A having a relation to B does not imply that B has a relation to A and vice versa.

A connection may have a set of attributes associated with it. Interpretation of these attributes depends upon the context in which the diagram is used. Shadow Diagrams supports the use of connection attributes the same way as Standard Diagrams do.

The Neighbors of a Shadow element are all the Shadow elements that the Shadow's Ports connect to. In a Shadow Diagram Neighbor Shadows are always located in the immediate vicinity (next) to each other.

There may be a plurality of connections between two MiMo or Uno Shadows. The Normal Shadow Diagram in FIG. 25 and FIG. 27 shows a plurality of right associative connections 7. Such a plurality of connections between two shadows will be called a Group Connection. To make Shadow Diagrams using MiMo or Uno Elements easier to read, they will purposely not be completely Planar at all times. The purpose of the present invention, called The Shadow Diagram Editor below, is to produce Diagrams that are easier to read and navigate than Standard Diagrams. Connections between Neighbor MiMo Shadows may display local non-planarity as shown in FIG. 64 and FIG. 65. We may imagine a variant of a MiMo Shadow where port identity is significant, but where the ports may change place to eliminate the local non-planarity.

With reference to the FIGS. 25, 26, 64 and 65. The Group Connection between Neighbor MiMo Shadows may be Collapsed into a Collapsed Group Connection 67: Collapsing a Group Connection connected to Shadow B's Exit Port will collapse the Group Connections 67 to all its Neighbors as shown as in FIG. 66. B will be displayed with one Exit Port and the Neighbors with one Entrance Port. The collapsed ports have the symbol E next to them to indicate that they have been collapsed. Each Group Connection between B and its Neighbors will each be shown as one Connection. The Shadow Graph is then again Completely Planar as seen in FIG. 66. The Group Connection can, at a later stage, be Expanded again to reveal the original connections as shown in FIG. 64.

With reference to the FIGS. 27 and 28. The Group Connection between Neighbor Uno Shadows may also be collapsed 68. An Uno Shadow has no dedicated Entrance and Exit ports, so the Collapse symbol E is displayed on the Collapsed Group Connection.

When using MiMo Shadows, the overall diagram is always planar, but there may exist local non-planar connections between Neighbor MiMo Shadows. Uno Shadows do not have any fixed connection points. It will therefore always be possible to arrange the plural connections between neighbor Uno Shadows in such a way that they are planar.

There are fundamentally different ways to draw Shadow Diagrams compared to Standard Diagrams. These differences are highlighted in FIG. 14 to FIG. 24. FIGS. 14 to 19 uses SiSo Shadows where port identity is significant. FIGS. 20 to 24 uses Uno Shadows where port identity is not significant. The Connection and Add/Delete rules, described later, are also fundamental to Shadow Diagrams. FIG. 14 and FIG. 15 shows the connection A→B represented by a Standard and Shadow Diagram respectively. FIG. 16 and FIG. 17 shows the connection A→B and B→A represented by a Standard and Shadow Diagram respectively. FIG. 18 and FIG. 19 shows the connection A←→B represented by a Standard and Shadow Diagram respectively. FIG. 20 and FIG. 21 shows the connection AB represented by a Standard and Shadow Diagram respectively. FIG. 22 and FIG. 23 shows the connection A←→B represented by a Standard and Shadow Diagram respectively, where FIGS. 23 and 24 show A←→B represented with Bidirectional and Unidirectional connections respectively.

Shadow Diagrams enforce the use of Multiple Shadows when several Shadows 35 want to connect to the same Shadow and when representing the following relationships: The relationship A→B and B→A for Shadows where connection ports are significant as shown in FIG. 17, or when representing the relationship A←→B for Uno Shadows as shown in FIG. 24.

In the Normal Shadow Diagram disclosed in FIG. 51, both Shadow element A and E wants to connect to B. However, since B may only receive connections from one Shadow at a time, this is done by using Multiple occurrences of B.

In the Standard Diagram in FIG. 56 it can be seen that the output port of A connects to the input port of E and the output port of E connect to the input port of A (A→E and E→A). In the associated Normal Shadow diagram disclosed in FIG. 57 this is represented as A→E→A using Multiple shadows of A.

This enforcement of Multiple Shadows are in agreement with the Shadow Connection Rules described herein. However, Multiple Shadows are not the same as Redundant Shadows, which is described below, and thus are treated differently in the Shadow Diagram

Shadow Diagrams also permits Redundant Shadows to exist in the Diagram. In a Normal Shadow Diagram a Shadow is said to be at Root Level when it has no Connection to is Entrance Port(s). In an Inverse Shadow Diagram a Shadow is said to be at Root Level when it has no Connection from its Exit Port(s). If there is more than one Root Level Shadow A present in a diagram, we have Root Level Redundant shadows. More formally, if N Root Level Shadows A are visible, N−1 Root Level Shadows A are redundant.

A Shadow A is said to be Contained in another Collapsed Shadow when it can be reached along Associative Connections from Node A in the Original Graph. A Root Shadow A is considered Redundant whenever A at the same time it is Contained within other Collapsed Shadows. More formally, if we have one Root Level Shadow A and more than one Contained Shadow A, the Root Level Shadow A is redundant. A Shadow may be both “Root Level Redundant” and “Contained Redundant”. If a Shadow is both Root Level and Contained Redundant, it will be treated as Root Level Redundant when deleted.

When a redundant Shadows is deleted, the Original Graph is not affected. In contrast, several Shadows and the Original Node may, according to the Shadow Add and Delete Rules, be deleted when a non-redundant Shadow is deleted.

With reference to the FIGS. 50, 51 and 52. The Shadow Element B in the Normal Shadow Diagram shown in FIG. 51 displays all Elements and connections that B has reference to along Right Associative Connections 7. The Inverse Shadow Diagram, shown in FIG. 52, displays all Elements and connections that have reference to B along Left Associative Connections 8.

The Inverse Shadow Diagram shown in FIG. 52 follows the same Connection and Add/Delete rules, described herein, as a Normal Shadow Diagram, but the role of Entrance and Exit Ports of the Shadow Elements have been switched. In a Normal Shadow Diagram, the Entrance Port(s) of any Shadow A may only receive Connection(s) from the Exit Port(s) of one Shadow B at a time, while the Exit Port(s) may each connect to the Entrance Port(s) of zero or many other Shadows. In an Inverse Shadow Diagram, the Exit Port(s) of any Shadow A may only connect to the Entrance Port(s) of one Shadow B at a time, while the Entrance Port(s) may each receive connections from the Exit Port(s) of zero or many other Shadows. The Inverse Shadow Diagram always stays in synch with the Normal Shadow Diagram. Any changes done in the Normal Diagram are immediately reflected in the Inverse Shadow Diagram and vice versa.

FIG. 51 and FIG. 52 uses SiSo Shadows. FIG. 63 shows a Standard Diagram with Milo Shadows, FIGS. 64 and 65 shows the equivalent Normal and Inverse Shadow Diagram respectively.

The Shadow Diagram Editor supports 3 simultaneous views of a diagram—Standard Diagram, Normal Shadow Diagram and Inverse Shadow Diagram. Given the Standard Diagram using SiSo elements in FIG. 50, the Normal Shadow Diagram is shown in FIG. 51 and the Inverse Shadow Diagram in FIG. 52. Given the Standard Diagram using MiMo elements in FIG. 63, the Normal Shadow Diagram is shown in FIG. 64, and the Inverse Shadow Diagram in FIG. 65.

A user draws and investigates diagrams in the Normal and Inverse shadow Diagrams as shown in FIG. 2.

It is also useful to have lists that display the different kinds of elements that we work with. With reference to FIG. 1 we have the Originals List 2 showing all original elements that constitute the Elements in the Original Graph 47 in FIG. 46. Elements may be dragged from this list and dropped in either the Normal or the Inverse Diagram to create a new Shadow of that element. The Shadows List 3 shows all Shadow elements currently drawn in the diagram. The Root Level List 4 shows all visible Shadow elements with no incoming connections, thus these Shadow elements are defined as Root elements. The Top Level List 5 shows all Shadow Elements that directly or indirectly refers to the currently selected Original Element in the Originals List.

The following data structure describes the Logical Implementation of the Shadow Diagram Editor. The actual Physical Implementation may be different. A Graph called the Original Graph 47, shown in FIG. 46 represents all the Elements and Connections in a diagram. The Connection are represented as Group Connections 42 in the Original Graph. A Group Connection contains the actual connections between two elements and may contain one or many connections depending upon how many connections there are between two elements. Each Node N 41 in the Original Graph has a collection of Group Connections that represent all the Nodes that N has a connection to/from The Original Graph is not visible. All Shadow elements 20 in a Shadow Diagram are “shadows” (or copies) of the elements 41 in the Original Graph.

Each Node 41 also has a Shadow Group 46 associated with it Each Shadow Group contains Shadow Items 40. Every Shadow in the Shadow Diagram belongs to a Shadow Group.

When Adding/Deleting Shadows and Connections 7 in a Normal Shadow Diagram, the Shadow Group is updated. The same is also true for Connections 8 in the Inverse Shadow Diagram. The Shadow- and Connection Add and Delete Rules, described below, specify how this updating is performed with this logical implementation.

When Expanding a Collapsed Shadow 20 a search algorithm is used to search the Original Graph 47 along associative connections from the particular start Node 41. The Shadows found are added to the Shadow Graph 48, and displayed on the Computer Screen. A detailed description of this operation is provided later.

When Collapsing a Shadow 20, a search algorithm is used to search the Shadow to Graph 48 along associative connections from the particular start Shadow 40. The Shadows found are removed from the Shadow Graph 48 and from the Computer Screen. A detailed description of this operation is provided later.

A Shadow Graph can always be derived from the Original Graph. The implication is that any Standard Diagram may be drawn as a Shadow Diagram using the principles and rules employed by the Shadow Diagram Editor.

Even if we don't use this type of implementation in a particular Shadow Diagram Editor implementation, we can use this metaphor to describe how it works.

To further see the difference between a Standard Diagram and a Normal Shadow Diagram, an example Standard Diagram is shown in FIG. 50, the Normal Shadow Diagram representation is shown in FIG. 51 and the Inverse Shadow Diagram in FIG. 52. The aim is to show that the Shadow Diagrams remains Planar and easy to navigate, while the standard Diagram has become non-planar and thus harder to read. The complete Shadow Diagram contains more elements than the equivalent standard Diagram. Both the Normal and Inverse shadow Diagram contains Multiple copies of elements A and B. However, when studying a diagram, we usually investigate which elements a particular element A has connections to (neighbors). This is very easy to see using the Normal and Inverse Shadow Diagram, since all elements connected to/from element A are always located next to element A. This is not the case in a Standard Diagram, and it is not in general possible to draw a standard diagram in such a way. The neighbors of element A may be scattered all over the diagram. The connection between the element A and the elements B, C and E in FIG. 51 demonstrate this.

The nature of Shadow Diagrams means that a single Element may represent an arbitrary complex Original Graph. The Original Graph 47 in FIG. 46 may bee seen by asking the Sadow Diagram Editor to generate a Standard Diagram. In the same way, the Sadow Diagram Editor supports a way of generating a Shadow Diagram that contains a minimum number of Elements. This is called a Minimum Shadow Diagram. A Minimum Shadow Diagram is not unique, thus there may be many equivalent representations. The Minimum Shadow Diagram consists of both a Minimum Normal Shadow Diagram and a Minimum Inverse Shadow Diagram.

A Minimum Shadow Diagram is drawn in such a way that all connections are represented, and each different Shadow is shown non-collapsed only once.

With reference to the FIGS. 4, 6, 8 and 10, a Diagram Element may be Collapsed. A collapsed Shadow is said to be in the Collapsed State, a non-collapsed shadow is in the Non-Collapsed State.

A collapsed Element represents a group of other Elements that is reachable following the Associative Connections in the Shadow Graph from the start Element. The Collapsed Element is represented by the Element we collapsed, but with a special Adornment, a blue Diamond 26. A Collapsed Folder or Shadow in a Shadow Diagram to will have all elements and connections reachable along Associative Connections im the Shadow Graph removed from the Computer Screen. The Relative Position Info and State (Collapsed or not) Info of each Shadow element is recorded in what we call the Collapsed Shadow Info. FIG. 59 shows a Normal Shadow Diagram before the Folder “Folder A” is collapsed FIG. 60 shows the diagram after Folder A has been collapsed. Finally FIG. 61 shows the diagram after Folder A has been moved to the right and expanded again.

We may perform a Reset Layout Operation on a Collapsed Element. This is indicated by the symbol 27. This operation resets the Relative Position Info for all Collapsed Elements reachable along Associative Edges in the Shadow Graph. It also sets the State of all elements found to the Collapsed state.

Given the Normal Shadow Diagram in FIG. 58 where the Folder A has been Collapsed in FIG. 59 and it can be seen what happens in FIG. 60 when we Expand Folder A again. The Collapse Operation was performed by searching the Shadow Graph. However, the Expand process is performed by searching along Associative Connections in the Original Graph The recorded Info (Collapsed Shadow Info) about Relative Position and Collapsed State is used to display the Shadows in the Shadow Graph in the same Relative Position and State that they had before the collapse, and to determine when to terminate the search.

New Nodes may be encountered in the Original Graph that where not present at the time of the Collapse. When this happens, the position of the equivalent Shadows relative to the existing Shadows are computed using a layout algorithm, and these Shadow will be displayed in the Collapsed State and the search terminates along this connection branch. The same happens when the Reset Layout Operation have been performed on Shadows. This process makes it easy to clean up a messy forest of Shadow elements that may occur when a Collapsed Shadow element with many connections is expanded.

The Shadow Diagram Editor supports a workflow that more closely resembles the way humans think of large systems, as separate “clusters” of elements. Folders help group these clusters. Each collapsed Folder and Shadow or Collapsed Group Connection can be Expanded both in the Normal and Inverse Shadow Diagram. In this way incrementally larger parts of a Diagram may be investigated while still maintaining a Planar diagram on the Computer Screen. (Local non-planarity may occur for Group Connections as described before). Any element can be dragged to the diagram and-be explored, regardless of its existence anywhere else in the diagram. Redundant elements may be added and deleted manually or automatically to help understand the diagram.

Redundant Elements and Inverse Diagrams are very useful tools in large diagrams. They help the Diagram designer keep focus on the elements currently being worked at. This is achieved without having to scroll the diagram back and forth to find the elements connected to each other. We may see this process in a few examples. Consider the Standard Diagram shown in FIG. 50. Starting at Shadow Element B, it has been partially expanded into a Normal Shadow Diagram shown in FIG. 51. We now collapse Shadow B and perform a Reset Layout operation on it; the result is shown in FIG. 53. B can now be Expanded to explore all Shadow elements that its exit port connects to, as shown in FIG. 54. By expanding Shadow C and D, we can explore all Shadow elements that C and D's exit ports connects to as seen in FIG. 55. Further, by expanding Shadow elements A, D and one of the Shadows E in FIG. 55, we get the diagram in FIG. 51. In the same way, we can at the same time study the Inverse Shadow Diagram and expand it progressively from Shadow B as shown in FIG. 52. This process demonstrates how the Shadow Diagram Editor allows the Designer to concentrate on the diagram elements that are important without getting lost in a spaghetti of on-screen elements. It is also worth noting that the diagram is easy to read with no connections crossing each other (planar graph). This makes the diagram easy to understand. The same process may be performed for the Inverse Shadow Diagram.

When a Shadow A in a Shadow Diagram is renamed to “B”, all other shadows with the name A are also renamed to B. If a Shadow A is attempted renamed to B, and the name B is already used by another shadow in the Diagram, A must be given a different name or it becomes a new redundant copy of B.

Renaming must be restricted so that the Connection Rules described herein are followed. As an example, given the shadows A and B connected as AB, It is not allowed to rename B to A, since a Connection rule, described below, states that a Shadow may not connect to itself.

Due to the unique characteristics of a Shadow Diagram, the Shadow Diagram Editor may also present the Normal and Inverse Shadow Diagram simultaneously in a 3D Shadow Diagram. This is done by presenting the Normal shadow Diagram in the XY plane, and the Inverse shadow Diagram in the YZ plane or vice versa. The Inverse shadow Diagram Shadows are then only expanded one Level. Using SiSo Shadows, the Diagram will still be Planar in both the XY and the YZ plane. This makes it easy to investigate all aspects of a certain group of diagram elements as seen in FIG. 62.

Connections may not be drawn between any combinations of Shadows in a Shadow Diagram. Connection Rules should be applied and prevent illegal connections to be drawn.

Two universal rules describes Normal and Inverse Shadow Diagrams with disregard to the type of Shadows used. In a Normal Shadow Diagram, the Entrance Port(s) of any Shadow A may only receive Connection(s) from the Exit Port(s) of one Shadow B at a time, while the Exit Port(s) may each connect to the Entrance Port(s) of zero or many other Shadows. In an Inverse Shadow Diagram, the Exit Port(s) of any Shadow A may only connect to the Entrance Port(s) of one Shadow B at a time, while the Entrance Port(s) may each receive connections from the Exit Port(s) of zero or many other Shadows.

Connections Rules

In the following discussion of Connection Rules and Add and Delete Rules, the rules are discussed in the context of a Normal Shadow Diagram. The same rules apply to is Inverse Shadow Diagrams, but then the role of Entrance and Exit ports are switched with respect to the rules. The following Associative Connections are invalid for All Shadows:

Connections to a Shadow's Entrance Port(s) from more than one Shadow at a time.

A Connection from any Exit Port to any Entrance Port of the same Shadow.

A Connection from Shadow A to another Shadow of A.

Feedback within a Shadow Graph is not allowed. Given A→B→C→D, a connection from e.g. D to e.g. A is illegal. To connect D to A, create a new Shadow of A (A′) and connect D to A′ as follows: A→B→C→D→A′.

Usually only Entrance and Exit ports of the same type may be connected to each other: Output ports to Input ports, and Superclass Ports to Subclass ports, but this is not a limitation in the design.

In the following discussion of Add and Delete Rules, the expressions Incoming Connections and Outgoing Connections will be used. In a Normal Shadow Diagram, the Incoming Connections of a Shadow are all connections to the Shadow's Entrance ports, and the Outgoing Connections of a Shadow are all connections to the Shadow's Exit ports. In an Inverse Shadow Diagram, the Incoming Connections of a Shadow are all connections to the Shadow's Exit ports, and the Outgoing Connections of a Shadow are all connections to the Shadow's Entrance ports. These definitions make it possible to write all Add and Delete Rules below using one set of terms.

The rules governing adding and deleting of Shadows and Connections are controlled by a few main principles. Whenever Connection between A and B or Shadow B is added or deleted, it is Shadow A that is modified. If there are duplicate representations of A in the Shadow Diagram, all these shadows must be updated. If B had no Incoming Connections, other Shadows are not affected. When the last Shadow B is deleted from a diagram and there are no Invisible representations of B inside other Collapsed Shadows, the equivalent Node B is removed from the Original Graph.

The rules are discussed in the context of SiSo Shadows and Normal Shadow Diagrams. However, the same rules apply to other types of Shadows as well. For Uno and MiMo Shadows we consider a Group Connection as one connection disregarding how many connections there is in the group. When special rules apply to a certain Shadow type, then this rule is mentioned after the discussion of the SiSo case. The rules for the Inverse Diagrams can be derived by switching the meaning Entrance/Exit ports as discussed above.

Given a Shadow A connected to a Shadow B (AB). If A is collapsed, we still consider B to have an Incoming Connection, and B is said to be Invisible. This is important in the discussion that follows.

A Connection Add Rule applies when adding Connection from an unconnected Shadow to a Shadow with or without no outgoing Associative edges.

Given N Shadows A with no outgoing connections, and one Shadow B with or without outgoing connections to other Shadows. Adding a connection from the Exit Port of one of the N Shadows A to an Entrance Port of Shadow B (A→B), will create N−1 Collapsed Shadows of B next to the other N−1 Shadows of A. A connection is added from the other N−1 Shadows of A to the N−1 new Shadows of B. The Original Graph is updated with a new Node B and a connection A→B is created. Note that the N−1 new Shadows of B will be collapsed whether they actually contain other Shadows or not. This is not an absolute requirement.

This rule is illustrated in the FIGS. 29, 30, 31 and 32 for SiSo Shadows.

The rule above also applies to the Group Connection between two MiMo (FIG. 25) or Uno (FIG. 27) Shadows A and B. When the first connection between A and B is added, the first Connection in the Group Connection is added and the rule above applies. Adding more connections between A and B just increases the number of connections in the Group Connection for all Shadows A→B in the Shadow Graph and in the Original Graph (FIG. 46).

This process is shown in the FIGS. 33, 34 and 35. FIG. 33 shows the situation before the first connection is created between the uppermost MiMo Shadow A and B. FIG. 34 shows what happens after the first connection has been created between the uppermost A and B (A.1→B.1). This connection triggers the Add Connection rule above. FIG. 35 shows what happens when additional connections are created between the uppermost A and B in FIG. 34: Only the connnections are duplicated for all Shadows A and B, and the Original Graph is also updated.

A Shadow Delete Rule applies when deleting Shadow with one incoming Associative Connection and with or without outgoing Associative Connections.

Given N Shadows A and N Shadows B, where each Shadow A has one Outgoing Connection connected to one Shadow B (with or without outgoing Connections). Also assume M Visible or Invisible Shadows B each with one Incoming Connection from a Shadow X. X is different from A and X may be collapsed. M>=0. Deleting one of the Shadows B (B′) with one incoming Associative Connection from a Shadow A, will delete all N Shadows B with one Incoming Connection from a Shadow A. Node B is deleted from the Original Graph if M=0. The M Shadows B with incoming connections from other Shadows than A are unaffected. All Connections and Shadows in the Shadow Graph reachable along associative connections from the N−1 Shadow B (other than B′) will also be deleted.

This rule is illustrated in the FIGS. 36 and 37. In FIG. 37, notice how the next uppermost Shadow B and all connections and shadows connected to it has been deleted. Also notice how the Shadows B that have connections from D and E where not deleted.

Given N Root Shadows A and N Shadows B and C. Each Shadow A has one outgoing Connection connected to one Shadow B and one Shadow C (with or without outgoing Connections). Also assume M Visible or Invisible Shadow A (inside other collapsed shadows). M>=0. Deleting one of the Root Shadows A, will delete, If N>1, only the selected Shadow A Or If N=1 and M=0, the selected Shadow A and the Original Node A is deleted from the Original Graph.

This is rule is illustrated in the FIGS. 38 and 39.

Given N Shadows A and N Shadows B where K of the Shadows B are Collapsed (K>=1). Each Shadow A has one outgoing Connection connected to one Shadow B. Also assume M Visible or Invisible Shadows B each with 1 Incoming Connection from a Shadow X, X is different from A and may be Collapsed. M>=0.

Deleting one of the K Collapsed Shadows B (B′) with one incoming Associative Connection from a Shadow A, will delete all N Shadows B with one Incoming Connection from a Shadow A. Node B is deleted from the Original Graph if M=0. All Shadows and Connections in the Original Graph reachable along associative connections from Collapsed Shadow B′ will be deleted if M=0. All Connections and Shadows in the Shadow Graph reachable along associative connections from the N-1 Shadow B (other than B′) will be deleted. If the last occurrence of a Shadow is deleted from the Shadow Group 46 of Shadows (FIG. 46), the equivalent Original Node is also deleted from the Original Graph. The M Shadows B with incoming connections form other Shadows than A are unaffected.

This rule is illustrated in the FIGS. 40 and 41. Both Shadows B that had an incoming connection from A in FIG. 40 and their reachable Shadows have been deleted in FIG. 41. All Original Nodes reachable from the equivalent Original Node B has been deleted (including Node B). Shadows B that has connections from other Shadows than A are unaffected.

Given N Collapsed Root Shadows A. Also assume M Visible or Invisible Shadows A (inside other collapsed shadows). M>=0. Deleting one of the Root Collapsed Shadows A, will If N>1, only delete the selected Collapsed Root Shadow A, or If N=1 and M=0, delete all Nodes in Original Graph reachable along Associative Connections starting at Node A. All equivalent Nodes in the Original Graph are deleted.

This is rule is illustrated in the FIGS. 42 and 43.

Given a set of Redundant Shadows. Deleting a Redundant Shadow, will delete only the Redundant Shadow from the Shadow Graph. The Original Graph is not affected.

A Connection Delete Rule applies when deleting a connection between two Shadows

Given the Shadows A, B, C, D connected in a Chain of Shadows A→B→C→D. Assume N of the Chains A→B→C→D are represented in a diagram. Also assume M Shadows C with incoming connections from other Shadows than A,B, C or D. Deleting Connection B→C, will delete the Connection B→C between all Shadows B and C in the Shadow Graph. In the Shadow Graph where the deletion of connection BC was initiated, the Graph of Shadows reachable by traversing Associative Connection from Shadow C is not changed. For all other Shadow Graphs, C and reachable Shadows from C are deleted. The Edge B→C is deleted from the Original Graph. The M Shadows C with incoming connections form other Shadows than A, B, C or D are unaffected.

This rule is illustrated in the FIG. 44 and FIG. 45.

The same rule applies to Group Connections between two MiMo Shadows. Initially when connections are deleted between two MiMo Shadows A and B, the Group Connection between all Shadows A and B in the Shadow Graph and Original Graph is updated. When the last connection in the Group is deleted, the Group Connection is deleted and the rule above applies.

This process is the reverse process of what happens in the Connection Add Rule above, as shown in the FIGS. 35, 34 and 33. FIG. 35 shows the situation before 30 deleting A.3→B.2 and A.4→B.5 and FIG. 34 shows the situation afterwards. FIG. 33 shows what happens after the last connection A.1→B.1 is deleted in FIG. 34.

1. A method for flexible generation and presentation of diagrams on a computer display consisting of elements and connections between these elements, characterized in displaying a diagram either partially or in full, allowing multiple occurrences of the same element, allowing redundancy of the same element, using diagram elements with different shapes and functions, displaying an element with all elements it has connections to next to it in a diagram called a Normal Diagram, displaying an element with all elements it has connections from next to it in a diagram called an Inverse Diagram, generating and/or displaying any partial diagram with any element in the diagram as a starting point, displaying arbitrarily complex diagrams in a simplified/collapsed manner, displaying, traversing and editing large and complex diagrams easily in a limited amount of space by collapsing and expanding elements, in a Normal Diagram only allowing the Entrance Port(s) of any Shadow A to receive Connection(s) from the Exit Port(s) of one Shadow B at any time while the Exit Port(s) may each connect to the Entrance Port(s) of zero or many other Shadows, in an Inverse Diagram only allowing the Exit Port(s) of any Shadow A to connect to the Entrance Port(s) of one Shadow B at any time while the Entrance Port(s) may each receive connections from the Exit Port(s) of zero or many other Shadows and displaying Normal- and Inverse diagram at the same time in a 3D diagram.

2. Method according to claim 1, characterized in displaying a diagram as a Normal Shadow Diagram by using right associative connections, where said connections represent all connection(s) that each Shadow connect to through its Exit Port(s).

3. Method according to claim 1, characterized in displaying a diagram as an Inverse Shadow Diagram by using left associative connections, where said connections represent all connection(s) that each Shadow receive to its Entrance Port(s).

4. Method according to claim 1, characterized in creating connections between elements in a Normal and Inverse Shadow Diagram where the connections have attributes associated with it and these attributes depend on the context in which the diagram is used.

5. Method according to claim 1, characterized in simplifying a Normal Shadow Diagram by collapsing a shadow element A, where said element will be marked as collapsed and all shadow elements along right associative connections will be deleted in the shadow diagram.

6. Method according to claim 1, characterized in displaying more details in a Normal Shadow Diagram by expanding collapsed shadow element A, where said element will expanded along right associative connections reachable in the Original Graph from the start element.

7. Method according to claim 1, characterized in simplifying an Inverse Shadow Diagram by collapsing a shadow element A, where said element will be marked as collapsed and all shadow elements along left associative connections will be deleted in the shadow diagram.

8. Method according to claim 1, characterized in displaying more details in an Inverse Shadow Diagram by expanding collapsed shadow element A, where said element will be expanded along left associative connections reachable in the Original Graph from the start element.

9. Method according to claim 1, characterized in displaying elements in diagrams as either Folder- or Shadow elements, where shadow elements can be further divided into, but not limited to, Uno, SiSo and MiMo shadow elements.

10. Method according to claim 1, characterized in that elements have entrance- and exit ports, where entrance- and exit ports are used to connect elements together according to connection rules.

11. Method according to claim 1, characterized in that elements can be connected either by unidirectional or bi-directional connections.

12. Method according to claim 1, characterized in that Normal and Inverse shadow diagrams can be represented, with Inverse diagrams expanded one level, in a 3D-model where Normal diagram elements are in the XY-plane and Inverse diagram elements in the YZ-plane.

13. Method according to claim 1, characterized in that a shadow diagram can be represented as a standard diagram and vice versa.

14. Method according to claim 1, characterized in that connections are added by creating a connection from an exit port of a shadow A to an entrance port of a shadow B, normally between the same type of exit and entrance ports.

15. Method according to claim 1, characterized in that connections cannot be created between entrance- and exit ports of the same shadow, between two shadows of the same element or feedback within a connected chain of Shadows, to any existing shadow element in the chain.

16. Method according to claim 1, characterized in a MiMo/Uno Shadow A may have many connections to its Entrance Ports when they all come from Exit Ports of the same MiMo/Uno Shadow B, i.e. A's Entrance Ports may not simultaneously receive connections from other Shadows than B.

17. Method according to claim 1, characterized in that SiSo Shadow only has one entrance- and one exit port, where the entrance port is normally located on the left or bottom side of the element while the exit port is normally located on the right or top side of the element.

18. Method according to claim 1, characterized in that a MiMo shadow has at least one entrance and at least one exit port, where the entrance port is normally located on the left or bottom side of the element while the exit port is normally located on the right or top side of the element.

19. Method according to claim 1, characterized in that an uno shadow has at least one invisible entrance- and invisible exit port, where the entrance- and exit ports may all go to the same point of the element or be distributed over the outer bounds of the element.

20. Method according to claim 1, characterized in given N Shadows A with no outgoing connections and one Shadow B with or without outgoing connections to other Shadows, then adding a connection from the Exit Port of one of the N Shadows A to the Entrance Port of Shadow B will lead to creation of N−1 Collapsed Shadows of B with connections next to the other N−1 Shadows of A, and the Original Graph is updated with a new Node B and a new connection A→B. Adding the first connection in a Group Connection between two MiMo/Uno Shadows A′ and B′, triggers the said rule, however, adding more connections between A′0 and B′ will only cause creation of new connections in the Group Connections between A′ and B′ in the Shadow Diagram and the Original Graph, not any new shadows.

21. Method according to claim 1, characterized in given N Shadows A and N Shadows B, where each Shadow A has one Outgoing Connection connected to one Shadow B, with or without outgoing Connections, assuming M visible or invisible Shadows B, where M>=0, each with one Incoming Connection from a Shadow C, which may be collapsed, then deleting one of the Shadows B (B′) with one incoming Associative Connection from a Shadow A, all N Shadows B with one Incoming Connection from a Shadow A and all Connections and Shadows in the Shadow Graph reachable along associative connections from the N−1 Shadow B (other than B′) are deleted, and if M=0, then Node B is deleted from the Original Graph.

22. Method according to claim 1, characterized in given N Root Shadows A and N Shadows B and C, where each Shadow A has one outgoing Connection connected to one Shadow B and one Shadow C, with or without outgoing Connections, assuming M, where M>=0, visible or invisible (i.e. inside other collapsed shadows) Shadows A, then deleting one of the Root Shadows A will lead to deleting only the selected Shadow A if N>1, and if N=1 and M=0, then the selected Shadow A is deleted and the Original Node A is deleted from the Original Graph.

23. Method according to claim 1, characterized in given N Shadows A and N Shadows B where K (K>=1) of the Shadows B are Collapsed, each Shadow A has one outgoing Connection connected to one Shadow B, assuming M, where M>=0, visible or invisible Shadows B each with one Incoming Connection from a Shadow C, which may be collapsed, then deleting one of the K Collapsed Shadows B (B′) with one incoming Associative Connection from a Shadow A will cause deletion of all N Shadows B with one Incoming Connection from a Shadow A and all Connections and Shadows in the Shadow Graph reachable along associative connections from the N−1 Shadow B (other than B′). However, if the last occurrence of a Shadow is deleted from the Collection of Shadows, the equivalent Original Node is also deleted from the Original Graph. If M=0, then Node B is deleted from the Original Graph and all Shadows and Connections in the Original Graph reachable along associative connections from Collapsed Shadow B′ will be deleted.

24. Method according to claim 1, characterized in given N Collapsed Root Shadows A, assuming M, where M>=0, visible or invisible (i.e. inside other collapsed shadows) Shadows A, then deleting one of the Root Collapsed Shadows A, only the selected Collapsed Root Shadow A is deleted if N>1, however, if N=1 and M=0, then all Shadows reachable by traversing the Shadow Graph along Associative Connections starting at the Collapsed Shadow A and all equivalent Nodes in the Original Graph, are deleted.

25. Method according to claim 1, characterized in given the Shadows A, B, C, D connected in a Chain of Shadows, i.e. A→B→C→D, assuming N of the Chains A→B→C→D are represented in a diagram and M Shadows C with incoming connections from other Shadows than A, B, or D, then deleting Connection B→C will cause deletion of all the Connections B→C between all Shadows B and C in the Shadow Graph. For the Shadow Graph where the deletion of Connection B→C was initiated, the Graph of Shadows reachable by traversing Associative Connection from Shadow C is not changed, however, for all other Shadow Graphs, shadow C and reachable Shadows from C are deleted and the Connection B→C is deleted from the Original Graph. Deleting a connection in the Group Connection between two MiMo/Uno Shadows A′ and B′ causes the same connection to be deleted between all present shadows of A′ and B′, and cecreases the number of connections in the Group Connection in the Shadow Diagram and in the Original Graph. Deleting the last connection in a Group connection between A′ and B′, triggers the said rule.
